(19) United States
(12) Patent Application Publication
(10) Pub. No.: US 2021/0319410 A1
(43) Pub. Date: Oct. 14, 2021

(54) VEHICLE MANAGEMENT SYSTEM AND INFORMATION PROCESSOR

(71) Applicant: TOYOTA JIDOSHA KABUSHIKI KAISHA, Toyota-shi (JP)

(72) Inventor: Makoto TANIGUCHI, Toyota-shi (JP)

(73) Assignee: TOYOTA JIDOSHA KABUSHIKI KAISHA, Toyota-shi (JP)

(21) Appl. No.: 17/186,400

(22) Filed: Feb. 26, 2021

(30) Foreign Application Priority Data
Apr. 8, 2020 (JP) 2020-069691

(51) Int. Cl. G06Q 10/00; G06Q 10/06; G06Q 50/30

(52) U.S. Cl. CPC G06Q 10/20; G06Q 50/30; G06Q 10/06312

(57) ABSTRACT

A vehicle management system that manages vehicles allocated to multiple allocation areas is configured to execute an obtaining process that obtains vehicle information including traveling tendencies of the vehicles, a calculation process that calculates degrees of deterioration of components of the vehicles based on the obtained vehicle information, and a reallocation process that changes the allocation area of a vehicle of which the degree of deterioration of a component is greater than or equal to a preset value to an allocation area that has a vehicle of which the degree of deterioration of the same component is less than the preset value.

### BACKGROUND

### 1. Field

The present disclosure relates to a vehicle management system and an information processor.

### 2. Description of Related Art

For example, Japanese Laid-Open Patent Publication No. 2019-168827 discloses a car-sharing system that manages vehicles allocated to different allocation areas. The system disclosed in the document optimizes parameters such as the number of vehicles to be allocated to each allocation area based on a prediction of demand for vehicles.

Components of a vehicle that deteriorate relatively rapidly vary depending on the traveling tendency of the vehicle (i.e. a traveling tendency toward frequent high-load driving and a traveling tendency toward frequent accelerating/decelerating traveling). The characteristics of traveling tendencies of vehicles differ from area to area. For example, in a mountainous area, a vehicle has a traveling tendency toward frequent high-load driving. In an urban area, a vehicle has a traveling tendency toward frequent accelerating/decelerating traveling. Accordingly, components that deteriorate relatively rapidly vary depending on the allocation area to which a vehicle is allocated. Thus, if allocation areas are fixed for respective vehicles, specific components tend to deteriorate more rapidly than other components. Therefore, the lives of the specific components expire earlier than those of other components. As a result, the useful life of a vehicle may expire prematurely although some of the components are still serviceable.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a vehicle management system that manages vehicles allocated to multiple allocation areas is provided. The vehicle management system comprises circuitry configured to execute: an obtaining process that obtains vehicle information including traveling tendencies of the vehicles; a calculation process that calculates degrees of deterioration of components of the vehicles based on the obtained vehicle information; and a reallocation process that changes an allocation area of a vehicle of which a degree of deterioration of a component is greater than or equal to a preset value to an allocation area that has a vehicle of which a degree of deterioration of the same component is less than the preset value.

In a general aspect, a vehicle management method of managing vehicles allocated to multiple allocation areas is provided. The method comprising: obtaining vehicle information including traveling tendencies of the vehicles; calculating degrees of deterioration of components of the vehicles based on the obtained vehicle information; and changing the allocation area of a vehicle of which the degree of deterioration of a component is greater than or equal to a preset value to an allocation area that has a vehicle of which the degree of deterioration of the same component is less than the preset value.

Other features and aspects will be apparent from the following detailed description, the drawings, and the claims.

### BRIEF DESCRIPTION OF THE DRAWINGS

FIG. 1 is a schematic diagram showing a vehicle management system according to an embodiment.

FIG. 2 is a block diagram showing a process executed by the execution device in FIG. 1.

FIG. 3 is a diagram showing degrees of deterioration of components in relation to traveling tendencies and temperature environments in different allocation areas.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

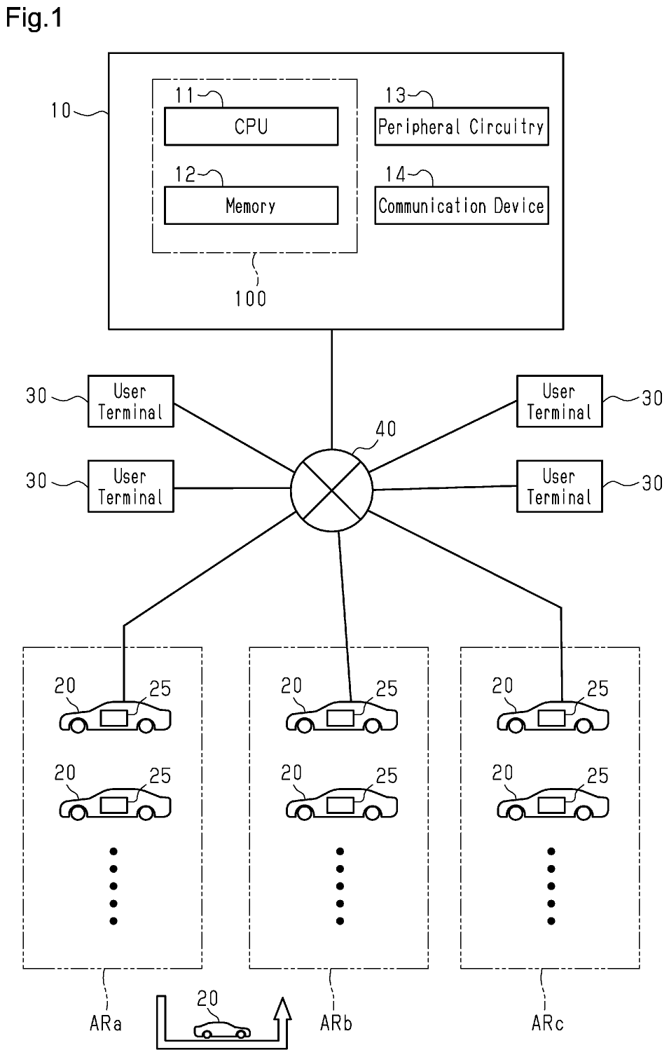

A vehicle management system according to an embodiment will now be described with reference to FIGS. 1 to 3.

The vehicle management system of the present embodiment is used for car-sharing, and includes an information processor 10, vehicles 20 each allocated to an allocation area AR, user terminals 30, and a communication network 40.

The information processor 10 includes a central processing unit (CPU) 11, a memory 12, peripheral circuitry 13, and a communication device 14, and executes various processes by executing programs stored in the memory 12 using the CPU 11. The CPU 11 and the memory 12 build an execution device 100. The information processor 10 intercommunicates with the respective vehicles 20 and respective user terminals 30 via the communication network 40. The information processor 10 executes various processes such as a process of receiving use request information for car-sharing from a user and lending a vehicle 20 to the user. The information processor 10 may include one or more information processors. Alternatively, the information processor 10 may include a cloud server or a virtual server.

The vehicles 20 are used for car-sharing and each include a controller 25, which controls power of a drive source (for example, an internal combustion engine or an electric motor) of the vehicle 20, and a shifting operation of a transmission. The controller 25 includes a CPU, a memory, peripheral circuitry, and a communication device, and intercommunicates with the information processor 10 via the communication network 40. Each vehicle 20 is also equipped with various sensors that detect various types of information, such as power requested by the vehicle driver, a rotation speed of the drive source, a vehicle speed SP of the vehicle 20, an acceleration/deceleration G of the vehicle 20, an outside air temperature THout around the vehicle 20, and a temperature THatf of automatic transmission fluid ATF, which is hydraulic oil of the transmission (hereinafter, referred to as an ATF temperature THatf). The sensors output detection signals to the controller 25.

Allocation of the vehicles 20 is basically managed for each of the allocation areas AR (FIG. 1 shows three allocation areas ARa, ARb, ARc out of multiple allocation areas AR), which are set by a classification setting process discussed below.

The user terminals 30 are used by users of the car-sharing, and may include smartphones, tablet terminals, portable terminals, laptop computers, desktop computers, and dedicated communication terminals for car-sharing. A user inputs, to the screen shown on the user terminal 30, use request information, which includes a departure point, a destination, a date of use, and time of use. The user terminal 30 delivers the use request information to the information processor 10, so that a reservation for use of the car-sharing is made.

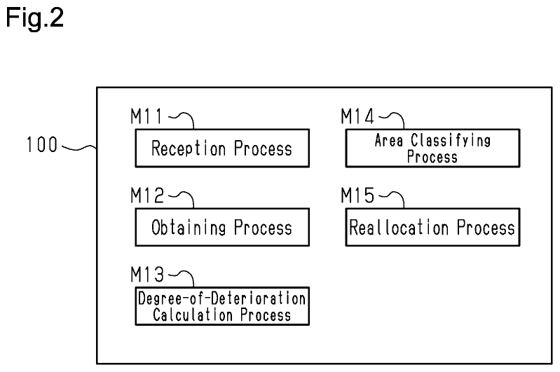

As shown in FIG. 2, the execution device 100 executes various processes, such as a reception process M11, an obtaining process M12, a degree-of-deterioration calculation process M13, an area classifying process M14, and a reallocation process M15.

The reception process M11 receives use request information from users of the car-sharing.

The obtaining process M12 obtains, from each of the vehicles 20, individual identification information of the vehicle 20 such as the vehicle identification number, information regarding the traveling tendency of the vehicle 20, and temperature information of the vehicle 20. The information regarding the traveling tendency includes the frequency of high-load traveling, the frequency of high-speed traveling, the frequency of accelerating/decelerating traveling, and the frequency of constant speed traveling.

The lower limit of an output torque TQ of the drive source at which the vehicle 20 is determined to be performing high-load traveling will be referred to as a threshold A. The frequency of high-load traveling refers to the ratio of cumulative traveling time during which the output torque TQ is greater than or equal to the threshold A to the total traveling time of the vehicle 20.

The lower limit of the vehicle speed SP at which the vehicle 20 is determined to be performing high-speed traveling will be referred to as a threshold B. The frequency of high-speed traveling refers to the ratio of cumulative traveling time during which the vehicle speed SP is greater than or equal to the threshold B to the total traveling time of the vehicle 20.

The lower limit of the acceleration/deceleration G at which the vehicle 20 is determined to be performing accelerating/decelerating traveling at a relatively large acceleration/deceleration will be referred to as a threshold C. The frequency of accelerating/decelerating traveling refers to the ratio of cumulative traveling time during which the acceleration/deceleration G is greater than or equal to the threshold C to the total traveling time of the vehicle 20.

A range of a change amount per unit time of the vehicle speed SP in which the vehicle 20 is determined to be traveling at a constant speed will be referred to as a range D. The frequency of constant speed traveling refers to the ratio of cumulative traveling time during which the change amount per unit time of the vehicle speed SP is within the range D to the total traveling time of the vehicle 20.

The temperature information of the vehicle 20 includes a change history of the outside air temperature THout, which is the temperature of the outside air to which the vehicle 20 is exposed, and a change history of the ATF temperature THatf.

The controller 25 of each vehicle 20 calculates the frequency of high-load traveling, the frequency of high-speed traveling, the frequency of accelerating/decelerating traveling, the frequency of constant speed traveling, the change history of the outside air temperature THout, the change history of the ATF temperature THatf, and periodically delivers the calculation results to the information processor 10.

The degree-of-deterioration calculation process M13 calculates, for each of the vehicles 20, the degree of deterioration of components of the vehicle 20 based on the vehicle information obtained by the obtaining process M12. The degree of deterioration is indicated by a value that is 0% for an unused component, and 100% for a component that can no longer be used. The degree-of-deterioration calculation process M13 calculates the degree of deterioration in the following manner.

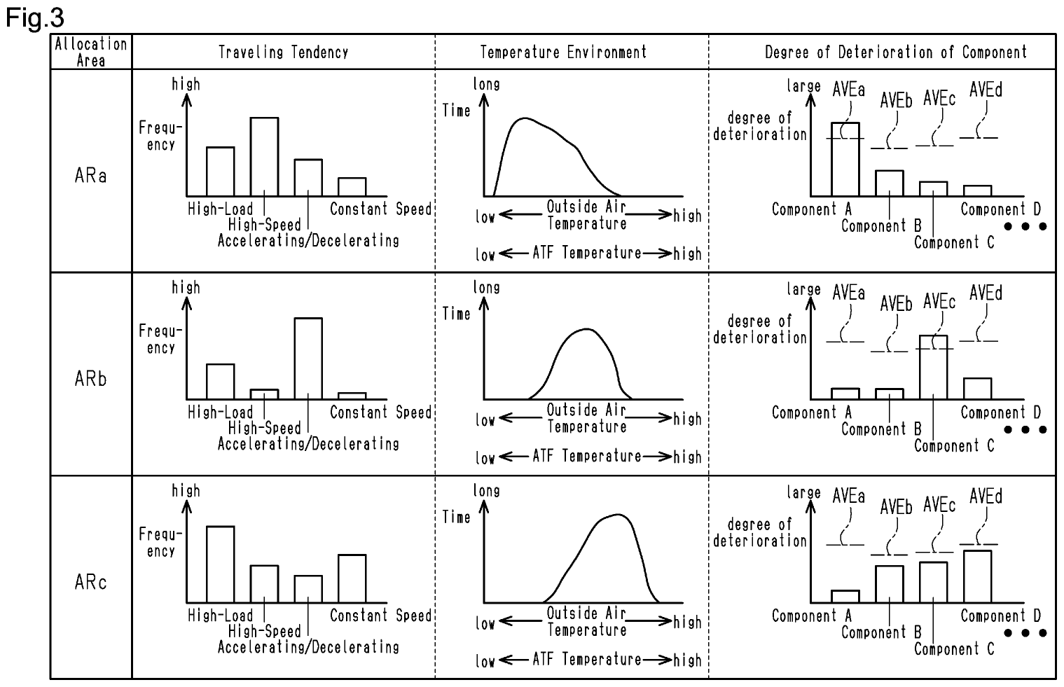

As the frequency of high-load traveling of a vehicle increases, gears of the drive train or the drive source (corresponding to a component D in FIG. 3) become more prone to wear. Accordingly, the execution device 100 calculates the degree of deterioration of the gears such that the degree of deterioration increases as the frequency of high-load traveling increases.

As the frequency of high-speed traveling of a vehicle increases, bearings of the drive train or the drive source (corresponding to a component A in FIG. 3) become more prone to wear. Accordingly, the execution device 100 calculates the degree of deterioration of the bearings such that the degree of deterioration increases as the frequency of high-speed traveling increases.

As the frequency of accelerating/decelerating traveling of a vehicle increases, gears in the differential case of the drive train or the oil pump in the vehicle 20 (corresponding to a component C in FIG. 3) become more prone to wear. Accordingly, the execution device 100 calculates the degree of deterioration of the gears in the differential case or the oil pump such that the degree of deterioration increases as the frequency of accelerating/decelerating traveling increases.

As the frequency of constant speed traveling of a vehicle increases, oil seals of the input shaft of the transmission or oil seals of the differential case (corresponding to a component B in FIG. 3) become more prone to wear. Accordingly, the execution device 100 calculates the degree of deterioration of the oil seals such that the degree of deterioration increases as the frequency of constant speed traveling increases.

Plastic components such as bushings of a drive source or a transmission, and moldings of an electric motor deteriorate more rapidly as the environmental temperature of the vehicle 20 increases. Bearings used in the vehicle 20, for example, bearings used in the drive source or the transmission, become more prone to deteriorate as the viscosity of lubricant increases due to a decrease in the environmental temperature of the vehicle 20.

Therefore, in the degree-of-deterioration calculation process M13, the execution device 100 calculates an amount of time during which the vehicle 20 has been exposed to low temperature from the change history of the outside air temperature THout. The execution device 100 calculates the degree of deterioration of the bearings used in the drive source such that the degree of deterioration increases as the calculated low temperature time increases. Likewise, the execution device 100 calculates an amount of time during which the vehicle 20 has been exposed to high temperature from the change history of the outside air temperature THout. The execution device 100 calculates the degree of deterioration of the plastic components used in the vehicle 20 such that the degree of deterioration increases as the calculated high temperature time increases.

Further, in the degree-of-deterioration calculation process M13, the execution device 100 calculates an amount of time during which the temperature of the transmission has been low from the change history of the ATF temperature THatf. The execution device 100 calculates the degree of deterioration of the bearings used in the transmission such that the degree of deterioration increases as the calculated low temperature time increases.

Further, the execution device 100 calculates an amount of time during which the temperature of the transmission has been high from the change history of the ATF temperature THatf. The execution device 100 calculates the degree of deterioration of the plastic components used in the transmission such that the degree of deterioration increases as the calculated high temperature time increases.

The area classifying process M14 classifies the allocation areas AR based on the traveling tendencies of the vehicles in the obtained vehicle information.

As shown in FIGS. 3 and 1, in the area classifying process M14, the execution device 100 classifies, as a first allocation area ARa, an area that has vehicles 20 of high values of the frequency of high-speed traveling (which is one of the frequency of high-load traveling, the frequency of high-speed traveling, the frequency of accelerating/decelerating traveling, and the frequency of constant speed traveling). Areas that are likely to be classified as the first allocation areas ARa include a rural suburb area that has a large number of straight roads with a small number of traffic lights.

The execution device 100 classifies, as a second allocation area ARb, an area that has vehicles 20 of high values of the frequency of accelerating/decelerating traveling. Areas that are likely to be classified as the second allocation areas ARb include an urban area in which vehicles frequently perform stop-start movements.

The execution device 100 classifies, as a third allocation area ARc, an area that has vehicles 20 of high values of the frequency of high-load traveling. Areas that are likely to be classified as the third allocation areas ARc include a mountainous area in which high-load traveling is likely to be performed due to uphill driving.

The reallocation process M15 changes the allocation area of a vehicle 20 of which the degree of deterioration of a component (one of the above-described types of components) is greater than or equal to a preset value to an allocation area that has vehicles 20 of which the degrees of deterioration of the same component are less than the preset value. That is, the execution device 100 calculates an average value of the degree of deterioration for each of the above-described components in all the vehicles 20 (for example, an average value AVEa of the component A, an average value AVEb of the component B, an average value AVEc of the component C, and an average value AVEd of the component D, which are shown in FIG. 3), and uses each of the average values as the above-described preset value. The execution device 100 changes the allocation area of a vehicle 20 of which the degree of deterioration of a component is greater than or equal to the preset value to an area that has vehicles 20 of which the degrees of deterioration of the same component are less than the preset value. More preferably, the execution device 100 changes the allocation area of a vehicle 20 of which the degree of deterioration of a component is greater than or equal to the preset value to an area that has vehicles 20 of which the degrees of deterioration of the same component are less than or equal to a value obtained by subtracting a predetermined value from the preset value, so that the degrees of deterioration are sufficiently lower than the present value.

The execution device 100 changes the allocation area AR of a vehicle 20 to another. For example, the degree of deterioration of the component A is greater than or equal to the average value AVEa in the first allocation area ARa as shown in FIG. 3. In contrast, the degree of deterioration of the component A is less than the average value AVEa in the second allocation areas ARb. The execution device 100 executes a process of changing the allocation area AR of the vehicle 20 allocated to the first allocation area ARa to the second allocation area ARb.

The transfer of such a vehicle 20 is executed through the process below. That is, the above-described use request information for car-sharing may include a departure point and a destination. The departure point may be in the allocation area AR that has a vehicle 20 of which the degree of deterioration of a component (the component A in the example of FIG. 3) is greater than or equal to the preset value (the first allocation area ARa in the example of FIG. 3), and the destination may be located in an allocation area AR that has a vehicle 20 of which the degree of deterioration of the same component is less than the preset value (the second allocation area ARb in the example shown in FIG. 3). In such a case, the execution device 100 executes, as the reallocation process, a process of lending to the user the vehicle 20 having the component (the component A in the example shown in FIG. 3), of which the degree of deterioration is greater than or equal to the preset value.

The present embodiment has the following advantages.

(1) Components of the vehicle 20 that deteriorate relatively rapidly vary depending on the traveling tendency of the vehicle 20 (e.g., a traveling tendency toward frequent high-load driving and a traveling tendency toward frequent accelerating/decelerating traveling). For example, in a mountainous area, a vehicle has a traveling tendency toward frequent high-load driving. In an urban area, a vehicle has a traveling tendency toward frequent accelerating/decelerating traveling. The characteristics of traveling tendencies of the vehicles 20 differ from area to area. Accordingly, components that deteriorate relatively rapidly vary depending on the allocation area AR to which a vehicle 20 is allocated. In this regard, the present embodiment executes the reallocation process M15 to transfer a vehicle 20 that has a component of which the degree of deterioration is greater than or equal to the preset value to an area in which the deterioration of that component does not progress rapidly. Accordingly, deterioration of components, which varies depending on the allocation area AR, is suppressed, so that deterioration of the components of the vehicles 20 is averaged. This in turn extends the useful life of the vehicles 20.

(2) As described above, the plastic components used in the vehicles 20 differ in the degree of deterioration depending on the temperature environment of the vehicles 20. Also, the bearings used in the vehicles 20 differ in the degree of deterioration in correspondence with changes in viscosity of the lubricant, which depends on the temperature environment of the vehicles 20. In this regard, in the present embodiment, the vehicle information that is referred to by the above-described degree-of-deterioration calculation process M13 includes temperature information of the vehicles 20, such as the outside air temperature THout and the ATF temperature THatf. This allows the degrees of deterioration of the plastic components and bearings to be calculated.

(3) The above-described area classifying process M14 is executed to classify the allocation areas AR based on the obtained traveling tendencies. Thus, the allocation areas AR of the vehicles 20 are classified in correspondence with the actual traveling tendencies of the vehicles 20. Accordingly, the allocation areas AR are properly classified in accordance with the actual deterioration of the components. This allows the reallocation process M15 to properly transfer the vehicles 20 in accordance with the deterioration of the components. Deterioration of the components of the vehicles 20 is thus suppressed properly as compared to a case in which the allocation areas AR are set in advance based on prediction of the traveling tendencies.

(4) The use request information is used at the execution of the above-described reallocation process M15. Accordingly, the vehicles 20 are transferred through the use of car-sharing by the users. Therefore, the vehicles 20 are transferred between the allocation areas merely through the use of the vehicles 20 in car-sharing. This allows for effective reallocation of the vehicles 20.

The above-described embodiment may be modified as follows. The above-described embodiment and the following modifications can be combined as long as the combined modifications remain technically consistent with each other.

In the above-described embodiment, the controller 25 of each vehicle 20 calculates the frequency of high-load traveling, the frequency of high-speed traveling, the frequency of accelerating/decelerating traveling, the frequency of constant speed traveling, the change history of the outside air temperature THout, and the change history of the ATF temperature THatf. Also, the controller 25 of each vehicle 20 repeatedly delivers, to the information processor 10, the values of the output torque TQ, the vehicle speed SP, the acceleration/deceleration G, the outside air temperature THout, and the ATF temperature THatf. However, the information processor 10 may calculate the frequency of high-load traveling, the frequency of high-speed traveling, the frequency of accelerating/decelerating traveling, the frequency of constant speed traveling, the change history of the outside air temperature THout, and the change history of the ATF temperature THatf.

The execution device 100 may calculate the degree of deterioration of a component different from the above-described components based on the above described traveling tendencies and temperature information.

The execution device 100 may also calculate the degree of deterioration of a component different from the above-described components based on a traveling tendency different from the above-described traveling tendencies.

The execution device 100 does not necessarily need to include the CPU 11 and the memory 12. For example, the execution device 100 may include a dedicated hardware circuit, for example, an application-specific integrated circuit (ASIC) that executes at least part of the software processes executed in the above-described embodiment. That is, the execution device 100 may be modified as long as it is circuitry that has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. Multiple software processing devices each including a processor and a program storage device and multiple dedicated hardware circuits may be provided.

The vehicle information delivered by the controller 25 of each vehicle 20 does not necessarily need to include the above-described temperature information. In this case, the advantages, except for advantage (2), are obtained.

The execution of the above-described area classifying process M14 may be omitted. The allocation areas AR, which are classified according to the traveling tendencies, may be different prefectures or municipalities. For example, Hokkaido may be classified as the first allocation area ARa, which has a high frequency of high-speed traveling. Tokyo Metropolis may be classified as the second allocation area ARb, which has a high frequency of accelerating/decelerating traveling, and Kyushu may be classified as the third allocation area ARc, which has a high frequency of high-load traveling. In this case, the advantages, except for advantage (3), are obtained.

In the above-described embodiment, the vehicles 20 are transferred through the use of car-sharing by the users. However, the vehicles 20 may be transferred in a different manner. For example, the execution device 100 may execute, as the reallocation process M15, a process of notifying the business operator of car-sharing of the vehicle 20 that needs to be transferred and the allocation area to which that vehicle 20 needs to be transferred. The business operator may then transfer that vehicle 20. In this case, the advantages, except for advantage (4), are obtained.

Further, in a case in which a vehicle 20 is capable of autonomously reaching a destination, a station in the allocation area to which the vehicle 20 is to be transferred may be designated as the destination, and the vehicle 20 may autonomously move to the destination.

The above-described vehicle management system may be used in applications other than car-sharing, as long as it is used to manage vehicles allocated to different allocation areas. For example, vehicles allocated to different allocation areas include buses and taxis, which are means of public transportation. If the above-described vehicle management system is used to manage such buses and taxies, the advantages, except for advantage (4), are obtained.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle management system that manages vehicles allocated to multiple allocation areas, the vehicle management system comprising circuitry configured to execute:
an obtaining process that obtains vehicle information including traveling tendencies of the vehicles;
a calculation process that calculates degrees of deterioration of components of the vehicles based on the obtained vehicle information; and
a reallocation process that changes an allocation area of a vehicle of which a degree of deterioration of a component is greater than or equal to a preset value to an allocation area that has a vehicle of which a degree of deterioration of the same component is less than the preset value.

2. The vehicle management system according to claim 1, wherein the vehicle information includes temperature information of the vehicles.

3. The vehicle management system according to claim 1, wherein the circuitry is configured to execute an area classifying process that classifies the allocation areas based on the obtained traveling tendencies.

4. The vehicle management system according to claim 1, wherein
the vehicle management system is a system used for car-sharing,
the circuitry is configured to receive use request information from a user of the car-sharing,
the use request information includes a departure point and a destination of a vehicle, and
the reallocation process includes a process that lends, to the user, a vehicle of which the degree of deterioration of a component is greater than or equal to the preset value in a case in which the departure point in the use request information is in an allocation area that has the vehicle of which a degree of deterioration of the component is greater than or equal to the preset value, and the destination in the use request information is in an allocation area that has a vehicle of which a degree of deterioration of the same component is less than the preset value.

5. An information processor, comprising the circuitry in the vehicle management system according to claim 1.

6. A vehicle management method of managing vehicles allocated to multiple allocation areas, the method comprising:
obtaining vehicle information including traveling tendencies of the vehicles;
calculating degrees of deterioration of components of the vehicles based on the obtained vehicle information; and
changing the allocation area of a vehicle of which the degree of deterioration of a component is greater than or equal to a preset value to an allocation area that has a vehicle of which the degree of deterioration of the same component is less than the preset value.
